(19) United States
(12) Patent Application Publication
(10) Pub. No.: US 2020/0281157 A1
(43) Pub. Date: Sep. 10, 2020

(54) Pet Animal Housing Unit With Safe Access To Grass On A Lawn

(71) Applicants: Wesley Yiming Liu, Warren, NJ (US); Stanley Yifei Liu, Warren, NJ (US); Zhiqiang Liu, Warren, NJ (US)

(72) Inventors: Wesley Yiming Liu, Warren, NJ (US); Stanley Yifei Liu, Warren, NJ (US); Zhiqiang Liu, Warren, NJ (US)

(21) Appl. No.: 16/297,658

(22) Filed: Mar. 10, 2019

(51) Int. Cl. A01K 1/03; A01K 1/02

(52) U.S. Cl. CPC A01K 1/032; A01K 1/0245

(57) ABSTRACT

The present invention is a pet cage having a upper cage member and a lower base member. The lower base member has a bottom that is partially cut out. An exchangeable plate or tray is provided and adapted to engage with the opening in the bottom of the lower base member. When an exchangeable plate or tray with access points, such as through-holes, are used, the pet can graze on fresh grass in a safe environment. When an exchangeable plate or tray without access points are used, the cage is restored to a conventional cage with closed bottom surface.

### FIELD OF THE INVENTION

The invention relates generally to improvements in animal housing units, and more particularly to animal enclosure construction that may be adjusted to provide an access point for caged pets to graze outdoors safely without leaving the safety of the housing unit.

### DESCRIPTION OF THE RELATED ART

Various types of animal housing units have been developed to house indoor pets. For example, rabbits, hamsters and guinea pigs are frequently confined in cages indoors. The cages come in various sizes, shapes and configurations.

U.S. Pat. No. 3,195,505 issued to F. C. Hauth et al. is an example of a small animal cage, the entire content of which is incorporated herein. The cage in Hauth comprises three main parts: an upper wire lattice portion forming the main enclosure, a grated or pervious floor portion, and a lower base portion. The grated or pervious floor portion is suspended above the floor of the lower base portion and serves to keep the animals away from its urine and droppings, which pass through the grated or pervious floor portion and land on the floor of lower base portion.

Hauth's three-part design is primarily tailored for the needs of laboratories. Cages designed for raising indoor pets typically do not contain a grated or pervious floor portion. Instead, the pet lives directly on the floor of the lower base portion. A layer of bedding is provided within the lower base portion to absorb the pet's urine and keep its droppings from contacting the lower base portion. The bedding is typically made of highly absorbent material, such as paper, wood shavings, etc. and may further contain chemical substances for absorbing, neutralizing or masking undesirable odors from the pet.

The three-part or two-part (without the grated or pervious floor portion) designs continue to be the mainstream designs more than fifty years after Hauth was issued. Of course, many changes have been implemented without departing from the overall design. For example, advancements in material sciences have led to the development of cheaper and more processable materials for manufacturing parts of a cage. Plastic is frequently used in place of metal for making the cage. Additionally, cages with more than one level of platform have been developed, such as those described in U.S. Pat. No. 5,964,189 to Northrop et al., and U.S. Pat. No. 6,318,295 to Wade, which are incorporated in their entirety herein.

While all of the above-referenced patents provide for useful cages, they do not permit the pet inhabitant to graze on fresh grass outdoors. Instead, the caged pets are typically fed indoors. At feeding time, the pet caretaker would bring food into the cage and place it within the food container. The food is often purchased, such as dried grass cuttings (hay), cucumbers, carrots and blueberries, which adds cost to the pet caretaker.

Feeding pets with fresh grass that is grown on a lawn or a meadow is an appealing concept for many pet caretakers for several reasons. First, fresh grass is often readily available for several seasons in a year. Many households, especially those located in rural or suburban areas, have lawns where fresh grass is grown during certain seasons each year. Second, using the fresh grass as a substitute for, or supplement to, purchased food reduces the cost of raising the pet. Third, many pets prefer to eat fresh grass from a lawn over purchased hay.

Despite the appeals of fresh grass, many pet caretakers have chosen not to use it as a substitute or supplement, at least not on a regular basis. This is because there have not been any convenient and safe methods for doing it. Taking the pet outside its cage and leaving it on the lawn often incur unacceptable level of risks. For example, eagles or hawks may circle the sky in certain rural areas, looking for prey. The pets may also escape from the lawn and venture into the wild or worse, traffic on the road. In light of these risks, some pet caretakers have chosen to collect fresh grass from outside, and then bring the grass indoors to feed the pets. In collecting the fresh grass, the pet caretakers frequently hold the tips of the grass with fingers of one hand and cut the grass with a pair of scissors or a knife held in the other hand. This process is both cumbersome and dangerous, and the pet caretakers risk cutting the fingers that hold the tips of the grass.

Known cage designs, including those described in the above patents, do not allow indoor pets to graze outdoors. Indoor pets living in these cages do not have access to grass even if the cages are brought outside and placed on the lawn. Therefore, there exists a need for a pet cage that can allow pets to safely reach fresh grass on a lawn or a meadow.

### BRIEF DESCRIPTION OF THE INVENTION

In a first embodiment of this invention, the pet cage comprises an upper cage member forming the main enclosure and a lower base member. The lower base member has a bottom and several sidewalls connected sequentially to enclose the bottom. An opening is created along the lower edge of a first sidewall and extends along the bottom toward the sidewall that opposes the first sidewall. Guides are provided along the edges of the opening for receiving and supporting an exchangeable plate. Exchangeable plates with different designs are provided, such as plates without any access points (e.g., through-holes), and plates with one or more access points. An exchangeable plate without any access point is used when access to grass is not desired, such as when the pet is housed indoors. A plate with one or more access points is used when access to grass is desired.

The second embodiment of the invention differs from the first embodiment in that guides are provided along the edges of the opening for receiving and supporting an exchangeable tray. Each exchangeable tray comprises two opposing sidewalls, a front plate, a bottom plate and preferably, a backplate. The exchangeable tray may be supported on the guides in different ways. For example, the bottom plate of an exchangeable tray may contact with and rest upon horizontally extending edges of the guides when the exchangeable tray is inserted into the opening. Alternatively, the top of the opposing sidewalls of the exchangeable tray may have horizontally extending lips or edges that may be perched on top the guides when the exchangeable tray is inserted into the opening. One or more exchangeable trays are provided with different bottom plate designs, such as a bottom plate without any access points or a bottom plate with one or more access points. An exchangeable tray with a bottom plate without any access points is used when access to grass is not desired, such as when the pet is housed indoors. An exchangeable tray with a bottom plate having one or more access points is used when access to grass is desired.

The third embodiment of the invention differs from the first embodiment in that guides are provided along the edges of the opening for receiving and supporting two or more exchangeable plates. When inserted into the opening, the exchangeable plates are placed substantially on top of each other and suspended at different heights from the bottom of the lower base member. Different exchangeable plates can be inserted as needed. For example, an exchangeable plate without any access points can be used above an exchangeable plate with one or more access points, when access to grass is not desired, such as when the pet is housed indoors. The top exchangeable plate can be removed when access is desired.

The fourth embodiment of the invention differs from the first embodiment in that the edge portions of the exchangeable plate have channels defined therein for receiving the corresponding edge portions of the opening in the bottom of the lower base member. In this design, no guides are needed along the edges of the opening of the lower base member. Exchangeable plates with different designs are provided, such as plates without any access points (e.g., through-holes), and plates with one or more access points. An exchangeable plate without any access point is used when access to grass is not desired, such as when the pet is housed indoors. An exchangeable plate with one or more openings is used when access to grass is desired.

### BRIEF DESCRIPTION OF THE DRAWINGS

The invention will be understood more readily from the following detailed description of the invention, when taken in conjunction with the accompanying drawings.

FIG. 1 is a view in elevation and partially in section of a pet cage in accordance with a first embodiment of the invention, wherein the pet cage is in a fully assembled state.

FIG. 2 is a perspective view of a pet cage in accordance with the first embodiment of the invention, wherein the pet cage is in an expanded state.

FIG. 3 is a greatly enlarged view in elevation and in section showing a portion of the upper grille section of the pet cage of FIG. 1.

FIG. 4 is a greatly enlarged view of the parts in FIG. 1 that are surrounded by 4-4.

FIG. 4A is a greatly enlarged view in perspective showing in detail a connecting hook member 30 in accordance with the first embodiment of the invention.

FIG. 5 is a greatly enlarged cross-sectional view of a portion of the lower base member surrounded by 5-5 in FIG. 1, and indicated by 5-5 in FIG. 2.

FIG. 5A is a top view of the parts shown in FIG. 5, as indicated by 5A-5A.

FIG. 5B is a first alternative design for the guide 50A as shown in FIG. 5.

FIG. 5C is a second alternative design for the guide 50A as shown in FIG. 5.

FIG. 6A is a top view of the body portion of an exchangeable plate without any access point in accordance with the first embodiment of the invention.

FIG. 6B is a top view of the body portion of an exchangeable plate having multiple small circular access points in accordance with the first embodiment of the invention.

FIG. 6C is a top view of the body portion of an exchangeable plate having two large circular access points in accordance with the first embodiment of the invention.

FIG. 6D is a top view of the body portion of an exchangeable plate having a rectangular access point in accordance with the first embodiment of the invention.

FIG. 7 is a perspective view of an exchangeable tray in accordance with a second embodiment of the invention.

FIG. 8 is a cross-sectional view of the exchangeable tray in FIG. 7 that is cut along the line 8-8 as the exchangeable tray engages with the lower base member.

FIG. 9 is a cross-sectional view of an exchangeable tray as the tray engages with the lower base member in accordance with an alternative design of the second embodiment of the invention.

FIG. 10 is a cross-sectional view of a portion of the lower base member in accordance with a third embodiment of the invention.

FIG. 11 is a cross-sectional view of a portion of the lower base member in accordance with a fourth embodiment of the invention.

FIG. 12 is a perspective view of a pet cage having a lower base member, a sidewall enclosure, and a lid with a trapezoidal cross section.

### DETAILED DESCRIPTION OF THE INVENTION

The invention is explained in connection with the following exemplary embodiments. They are provided as examples to facilitate the description of the invention and should not be regarded as exclusive embodiments. As discussed below, multiple variations can be made to the design of the cage without departing from the spirit or scope of the invention.

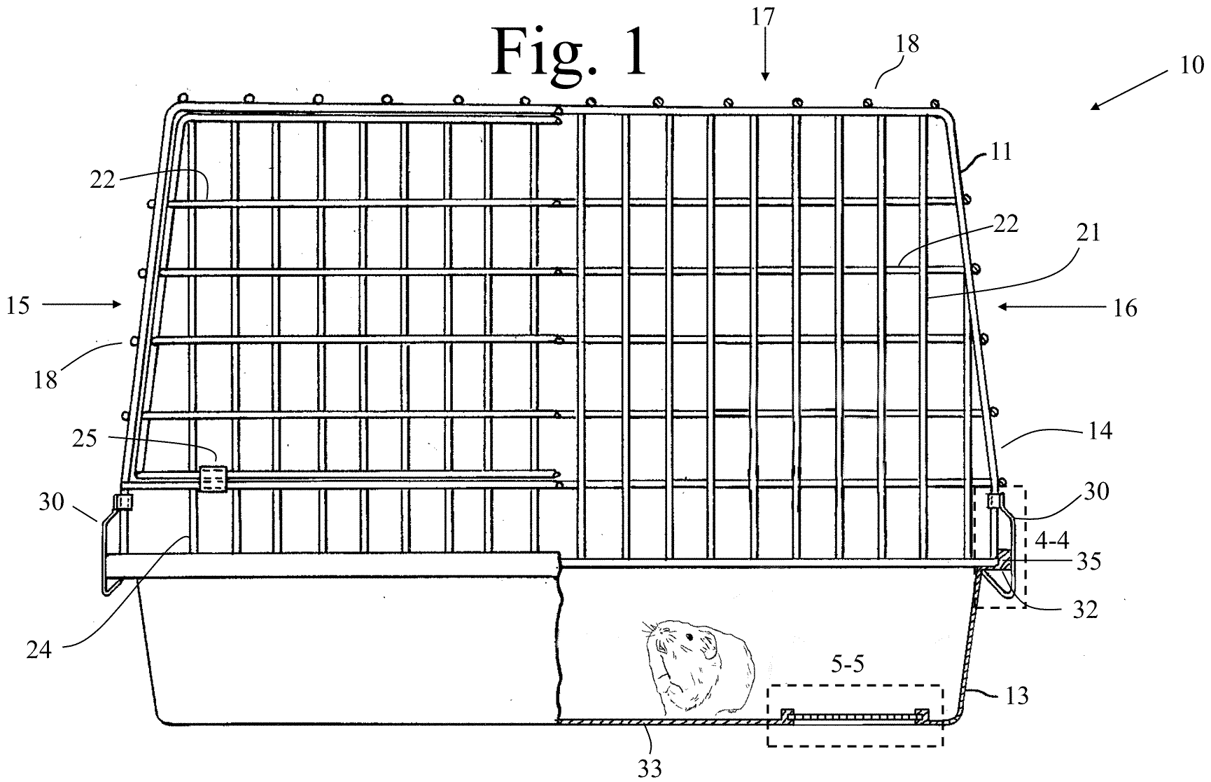

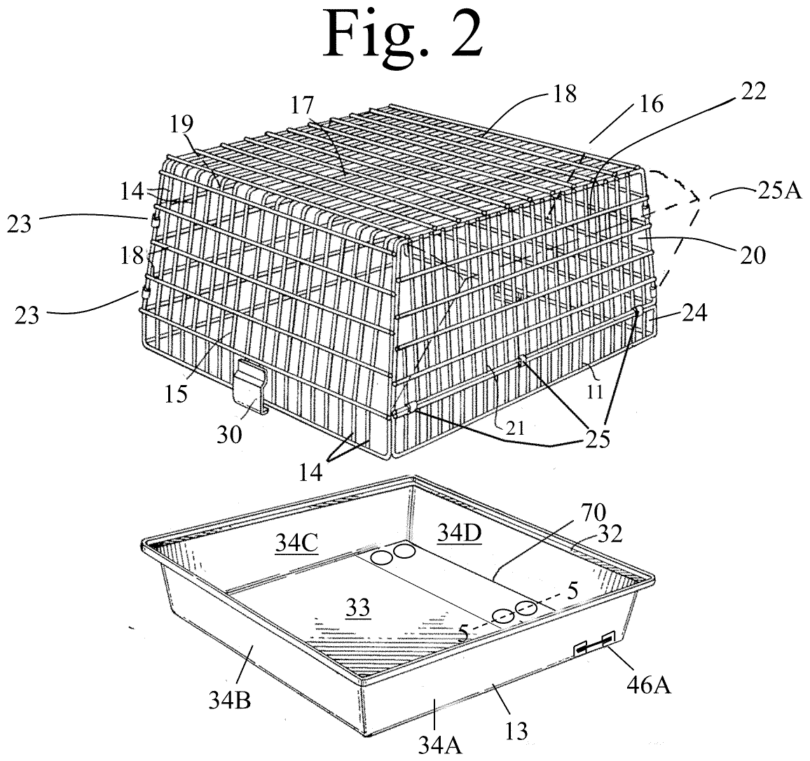

The first embodiment of the invention is illustrated in FIGS. 1 through 6D. FIG. 1 shows a pet cage 10 as it appears when fully assembled and in use indoors. The cage 10 comprises two major components, namely, an upper cage member 11 and a lower base member 13, which are shown in a detached state in FIG. 2. Both components preferably have a frusto-pyramidal configuration, although other configurations, such as a cube, rectangular prism, or another geometric shape may also be used without departing from the spirit or scope of this invention.

As shown in FIGS. 1 and 2, the upper cage member 11 of the cage 10 is preferably made from a plurality of rigid wire members which are preformed and joined together to form a mesh enclosure of the desired size. The mesh enclosure enables the following: air exchange between the pet cage and the environment, ambient light to reach the pet, the caretaker to see inside the cage and observe the pet, and the pet to see outside the cage. A central portion of the upper cage member 11 is formed by a series of inverted generally U-shaped and spaced apart wire members 14. The wire members 14 form opposite side members 15 and 16 and a roof portion 17. A series of spaced apart horizontal wires 18 are provided on the side members 15 and 17 and the roof portion 17. The wires 18 extend across and are joined to the wire members 14 (preferably at a 90 degree angle) to form the mesh pattern of this central section. The other sides of the upper cage member 11 are formed by separate upright side members 19 and 20, which are formed from a series of vertical wire members 21 and horizontal wire members 22. The side member 19 is fixed to the central portion of the upper cage member 11 between the sides 15 and 16 by clips or bands 23 that extend around the edge wire members of both the central member and the side member 19. The other side member 20 is hinged to a horizontal frame member 24, which is connected to the opposite sides 15 and 16 near the bottom edge of the upper cage portion 11, by a series of clips or bands 25 so that it can pivot thereon and provide a door 25A for the cage.

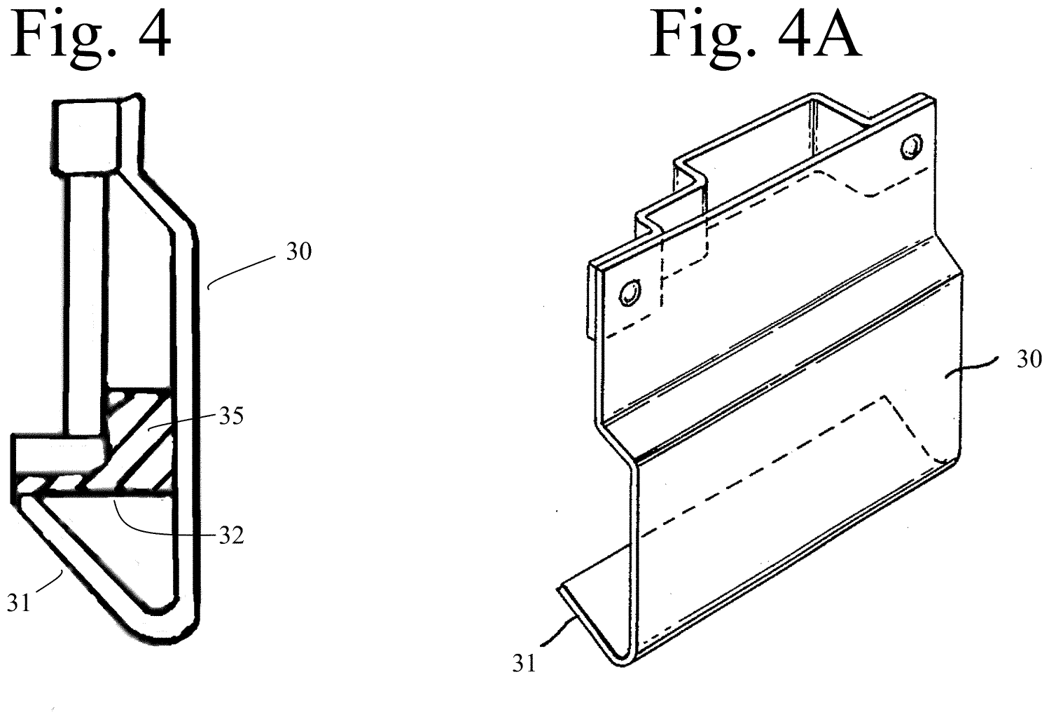

As shown in FIGS. 1 and 2, the lower base member 13 is where the pet, such as our guinea pig, Cinnamon, as depicted in FIG. 1, resides. The lower base member 13 is made from a sheet material and has a generally rectangular bottom 33 and a frusto-pyramidal shape formed by upwardly divergent sidewalls 34A, 34B, 34C and 34D. The bottom 33 can also be shaped other than a rectangle or a square, in which case, multiple sidewalls are provided to fully enclose the bottom 33. Instead of extending in an upwardly divergent manner, the sidewalls can also extend upwardly with a straight angle relative to the bottom 33. In either case, the sidewalls are connected in serial, i.e., one after another along shared edges (e.g., 34A to 34B, 34B to 34C, 34C to 34D, 34D to 34A), to form an enclosure. The enclosure has a top perimeter and a bottom perimeter. Around the top perimeter is a horizontally extending edge flange portion 32 of uniform width. The horizontally extending edge flange portion 32 is connected at its outer edge to an upwardly extending edge portion 35 (see FIG. 4). The top perimeter is adapted to receive the upper cage member 11 as discussed below. The bottom perimeter meets with the perimeter of the bottom 33 so that the enclosure and the bottom 33 are of an integral construction or separately formed but joined to each other.

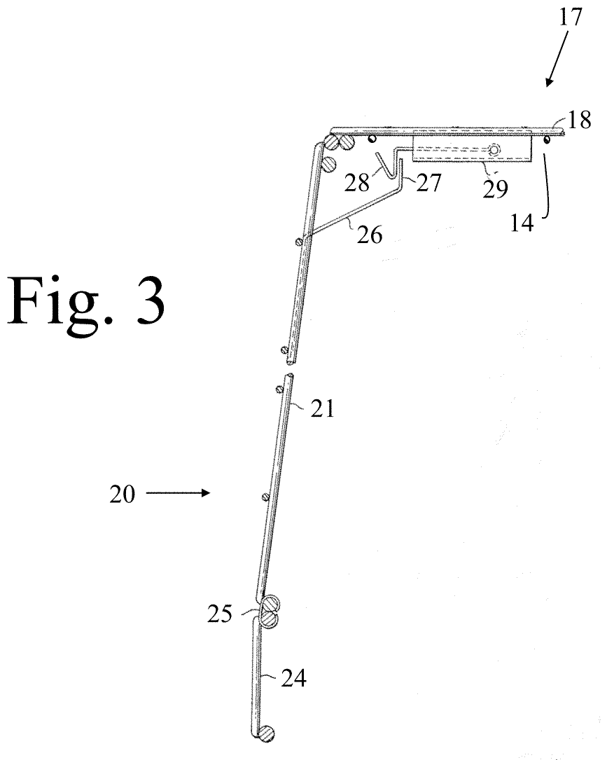

FIG. 3 illustrates a portion of the upper cage member 11 that is designed for regulating the door 25A. The door 25A is controlled by a latch 26 and a catch member 29. The latch 26 is provided on the side member 20 and comprises a resilient sheet member with a bent end flange 27. The catch member 29 is fixed to the roof portion 17 and comprises an end hook 28. The latch 26 is adapted to interact with the end hook 28, and when it fits behind the end hook 28, the interaction will keep the door 25A in a closed state. When the door 25A moves from an open position toward a closed position, the bent end flange 27 first touches the front (left) side of the end hook 28. Further movement of the door 25A will deform latch 26 and the bent end flange 27, effectively causing the bent end flange 27 to move downward, and at the same time, the end hook 28 deforms and moves upward. When the bent end flange 27 moves past the end hook 28 and comes into contact with its back (right) side, the latch 26, the bent end flange 27 and the end hook 28 will return to their undeformed state with the bent end flange 27 securely resting on the back side of the end hook 28 to keep the door 25A in the closed position. To open the door 25A, the end hook 28 is pushed upward, and/or the latch 26 and the bent end flange 27 are pushed downward. At this time, the end hook 28 and the bent end flange 27 will disengage, allowing the door 25A to be opened.

FIGS. 4 and 4A provide detailed views of the connecting hook member 30 and the top perimeter of the enclosure formed by the sidewalls of the lower base member, as shown in FIGS. 1 and 2. The connecting hook member 30 is provided on one or more sides of the cage for releasably connecting the upper cage member 11 and the lower base member 13. The connecting hook member 30 is formed from resilient sheet material. At its upper end, the connecting hook member 30 is adapted to releasably connect to some vertical and/or horizontal wire members in the upper cage member 11. The upper end can be designed as shown in FIG. 4A, or can be a simple tab (such as the lower lip portion 31) that engages a horizontal wire member in the upper cage member 11. At its lower end, the connecting hook member 30 is adapted to releasably connect to the lower base member 13. This is achieved by incorporating an inwardly and upwardly extending lower lip portion 31 that is adapted to fit around and under the horizontally extending edge flange portion 32 on the lower base member 13.

When the upper cage member 11 and the lower base member 13 are connected by one or more connecting hook members 30, the horizontally extending edge flange portion 32 directly supports the weight of the upper cage member 11 and passes the weight downward into the sidewalls, and the upwardly extending edge portion 35 forms an enclosure around the lower edge of the upper cage member 11 to prevent the upper cage member 11 from moving laterally in relation to the lower base member 13. When all hook members 30 are removed, the upper cage member 11 and the lower base member 13 can be separated.

As shown in FIGS. 1 and 2, the lower base member 13 is partially cut out in at least one sidewall as well as in the bottom to permit the pet to access grass when needed. The sidewall 34A of the lower base member is partially cut out, creating a side opening 46A at a location where the sidewall 34A meets the bottom 33.

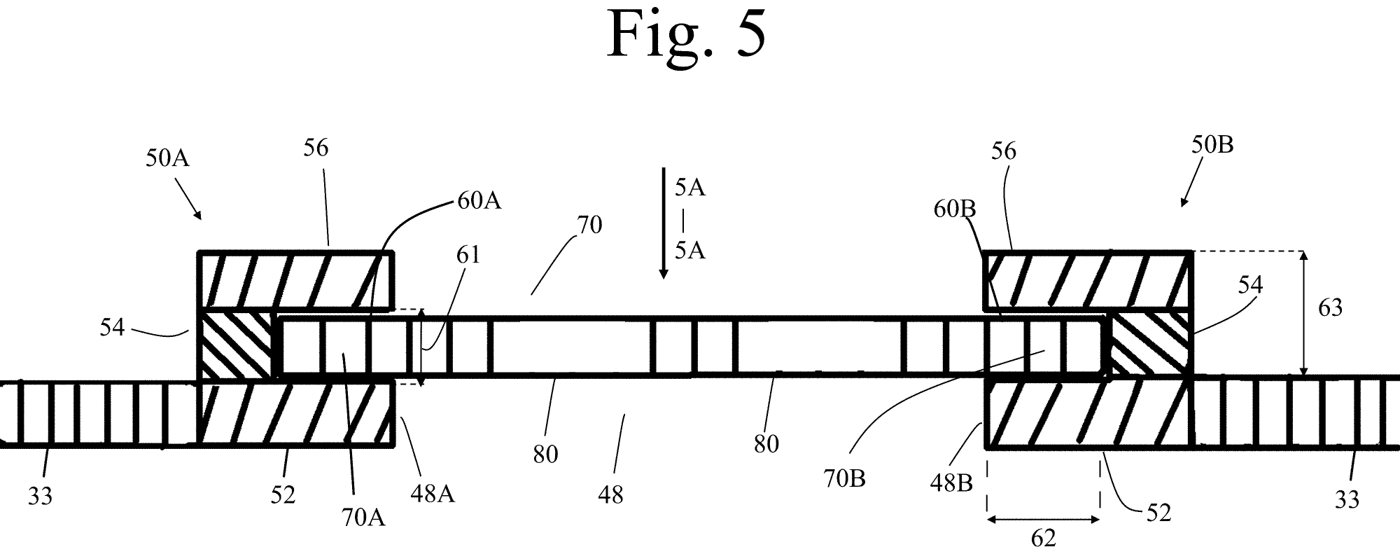

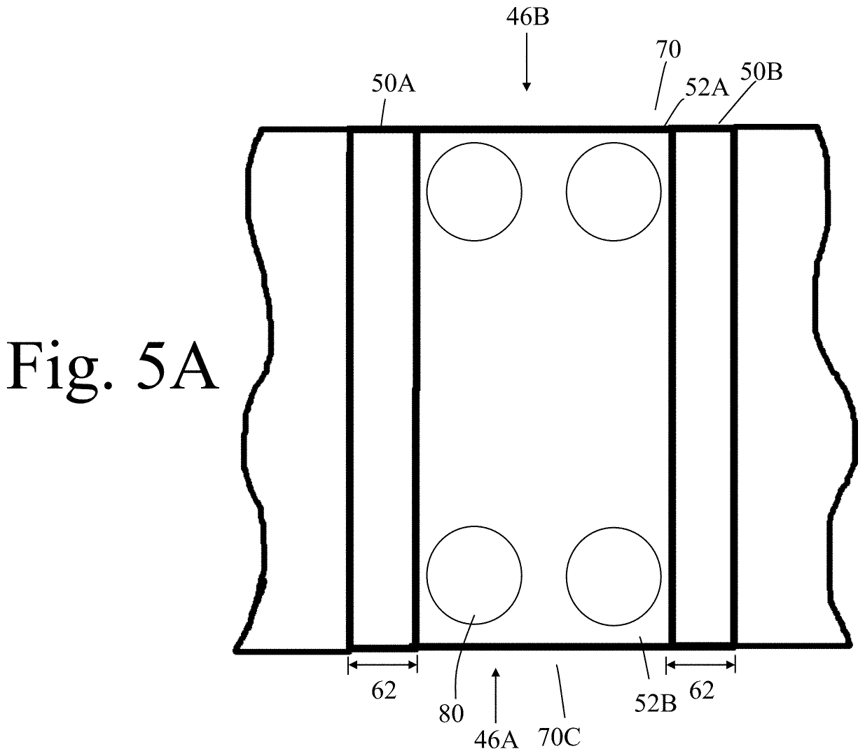

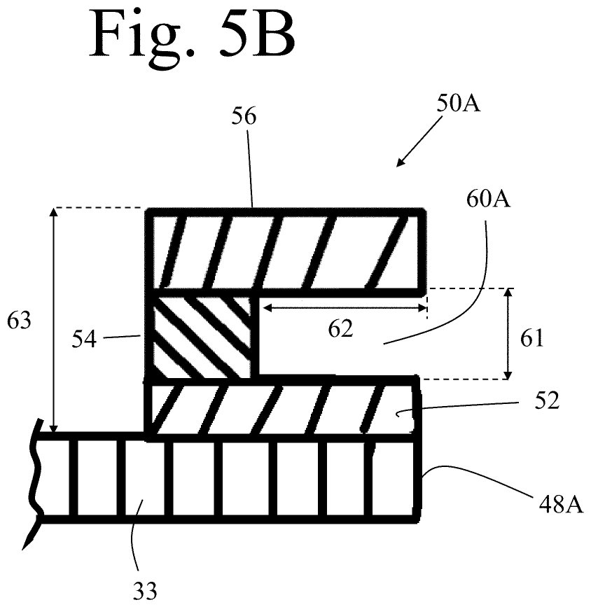

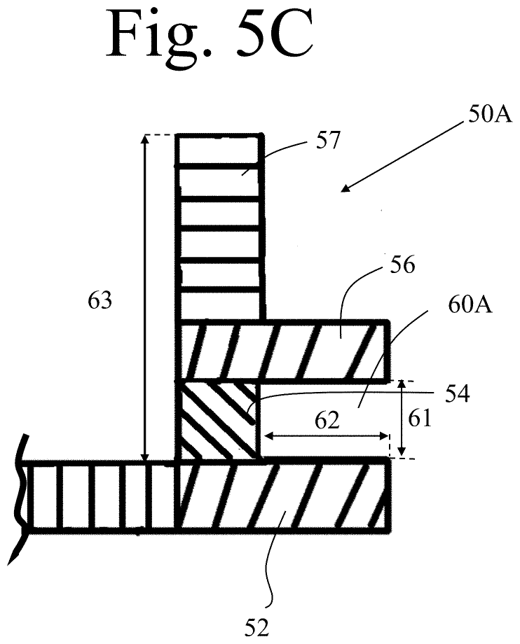

FIG. 5 is a cross-sectional view of a portion of the bottom of the lower base member 11, where access points are provided (as indicated by 5-5 in FIGS. 1 and 2). As shown in FIG. 5, the bottom 33 of the lower base member 13 is partially removed, creating a bottom opening 48 that is defined by the gap between two opposing edges 48A and 48B on the bottom 33. The edges 48A and 48B preferably run parallel to each other. The bottom opening 48 has a first end and a second end. On the first end, the bottom opening 48 connects with the side opening 46A. In the direction of the second end, the bottom opening 48 runs through the interior of the bottom 33 away from the sidewall 34A, preferably in a direction that is perpendicular to the sidewall 34A. The bottom opening 48 may extend partially or the entire distance to the sidewall 34C, which is directly or substantially opposite to the sidewall 34A. If the bottom opening 48 reaches the sidewall 34C, it may terminate as it reaches the sidewall 34C, leaving the sidewall 34C intact. Alternatively, the bottom opening 48 may terminate as a side opening 46B on the sidewall 34C, which mirrors the side opening 46A on the sidewall 34A.

A guide 50A is provided adjacent and along the edge 48A of the bottom opening 48. Similarly, a guide 50B is provided adjacent and along the edge 48B of the bottom opening 48. Each guide runs the entire length of the bottom opening 48 (i.e., from the first end to the second end of the bottom opening 48), and has bottom, side and top portions identified as 52, 54, and 56, respectively. The portions 52, 54 and 56 are preferably formed as a unitary structure. They also can be formed as separate elements and then assembled using any conventional means, such as using a glue or a fastener (screws, bolts/nuts, etc.). The bottom portion 52 can merge into the bottom 33 adjacent to the edges 48A and 48B (as shown in FIG. 5), or can be a separate element placed on top and attached to the bottom (as shown in FIG. 5B). In the latter case, the bottom portion 52 can be attached to the bottom by any conventional means, for example, by forming them as a unitary structure using a mould or forming them as separate elements that are connected using a glue or a fastener (screws, bolts/nuts etc.). The middle portion 54 projects away from the bottom 33 in the direction of the upper cage member 11. The top portion 56 is placed on top and connected to the middle portion 54, and runs substantially parallel to the bottom 33.

The bottom, middle and top portion (52, 54 and 56) along each edge (48A or 48B) cooperate to define a recessed space (60A or 60B) for engaging an exchangeable plate 70. The recessed space (60A or 60B) has a length, a height 61, and a depth 62. The length of the recessed space is the same as the length of the guide, and the length of the bottom opening 48. The guides are preferably dimensioned such that at its highest point, the distance 63 from the bottom 33 is similar to or more than the depth of bedding that is typically used for the pet cage. For example, the distance 63 can be about 1 to 3 inches, and preferably about 2 inches. If necessary, the top portion 56 may possess an element 57 that extends away from the bottom 33 so as to create the desired distance 63 (see FIG. 5C).

As shown in FIGS. 5 and 5A, an exchangeable plate 70 is provided to regulate the pet's access to grass. The exchangeable plate 70 has two edge portions (70A and 70B) for engaging with the corresponding recessed space (60A or 60B), and a body portion 70C. The surfaces of the edge portions 70A and 70B and the matching surfaces of the recessed space 60A and 60B can be smooth surfaces. Alternatively, these surfaces can modified to enhance friction when the edge portions 70A and 70B and the surface of the recessed space 60A and 60B are engaged with each other. The surfaces can be modified (e.g., roughened) using any conventional means, such as those disclosed in U.S. 2008/0038453 to Atsushi Yusa et al., DE19729891A1 to Hartmut Sauer, U.S. Pat. No. 5,826,586 to Ajit K. Mishra et al., and EP0875360A2 to Herbert Horn, et al, which are incorporated herein. As a further alternative, the edge portions 70A and 70B may be adapted to releasably engage with the recessed space 60A and 60B using the locking pin and detent hole combination as taught in U.S. Pat. No. 4,966,020 to Scott M. Fotheringham et al. (see e.g., column 5, lines 34-46, FIGS. 5-7), which is incorporated herein. In this design, one or more locking pins will be placed in each of the edge portions 70A and 70B, and detent holes are created in matching locations in the top portion 56 of the guides 50A and 50B.

The length of the exchangeable plate 70 is substantially the same as the length of the bottom opening 48 from the latter's first end to the second end. The width of the body portion 70C of the exchangeable plate 70 is substantially the same as the width of the bottom opening 48, i.e., the gap between 48A and 48B. The width of the edge portions 70A and 70B is substantially the same as the depth 62 of the recessed space 60A and 60B. The thickness of the edge portions 70A and 70B of the exchangeable plate 70 is substantially the same as the height 61 of the recessed space 60A or 60B. The body portion 70C may have the same or a different thickness as that of the edge portions 70A and 70B.

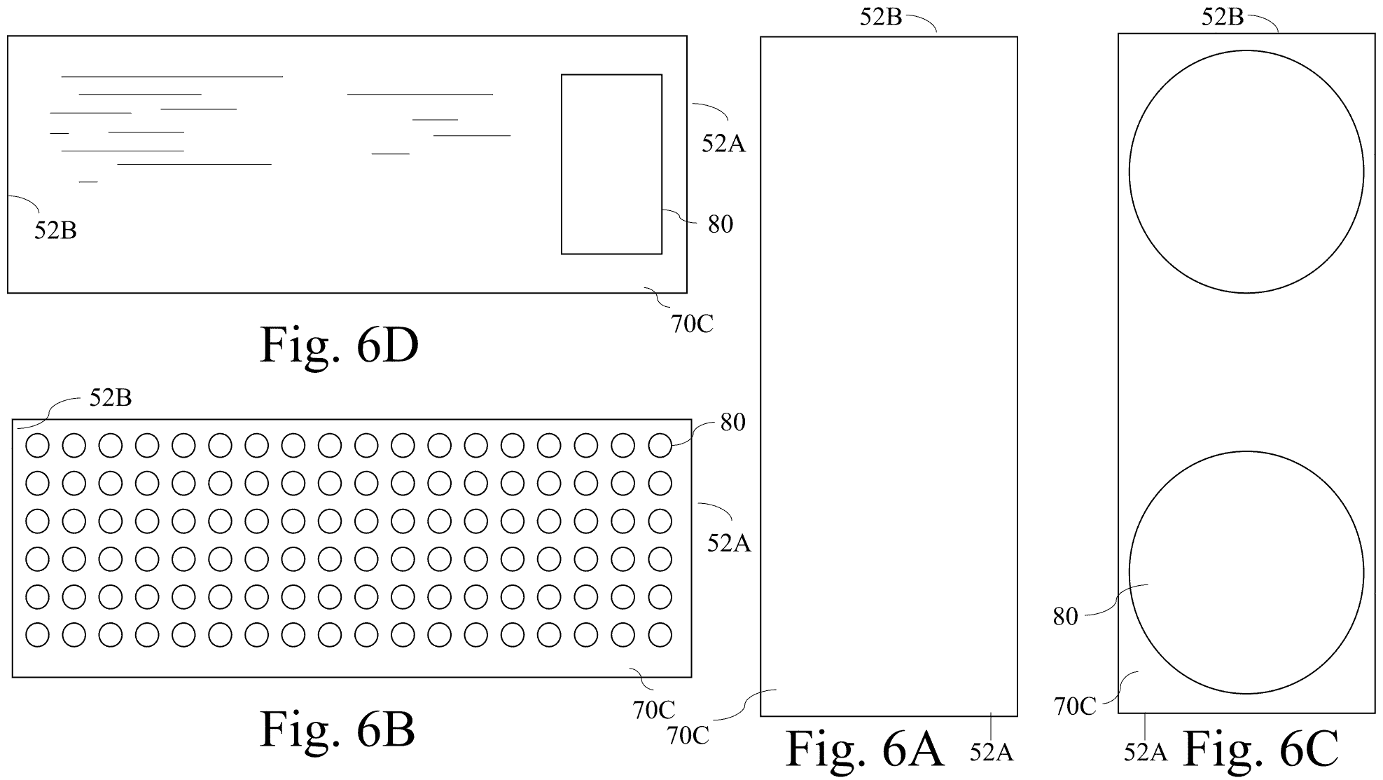

The body portion 70C of the exchangeable plate 70 can be designed in multiple formats for use under different situations. For example, in a first design (FIG. 6A), the plate does not have any access points, which is used when access to grass is not desired. In other designs (FIGS. 6B, 6C and 6D), the plate can have one or more access points (e.g., through-holes 80). When the pet cage is placed on the lawn, the pet can access the grass through the through-holes 80. The holes can be in any suitable size and geometric shapes, including circular , oval-shaped, star-shaped, rectangular, square, etc.

The exchangeable plate 70 can be readily installed on or removed from the lower base member 13. To install an exchangeable plate, the caretaker would insert a first end (52A, see FIG. 5B) of the exchangeable plate 70 into the side opening 46A on the lower base member 13, with the edges 70A and 70B inserted into the corresponding recessed space 60A and 60B. The caretaker would then continue pushing the plate into the interior of the bottom 33 until the exchangeable plate 70 is fully inserted, at which point 70C substantially covers up the entire bottom opening 48. As fully inserted, the second end 52B of the exchangeable plate 70 abuts the side opening 46A. The first end 52A of the exchangeable plate 70 abuts the inside of the opposing sidewall 34C or, if a side opening 46B is provided on the side wall 34C, the side opening 46B. To remove a plate, the caretaker would pull the plate toward either the side opening 46A or 46B until the plate is completely disengaged from the lower base member 13.

Gripping means are provided on the exchangeable plate 70 to facilitate the insertion or removal by hand. The gripping means can be depressions or small through-holes formed into the underside of the exchange plate 70 for receiving fingers. The gripping means can also be loops, rings, handles, knobs, bars and/or lips formed into or attached to the ends 52A and/or 52B.

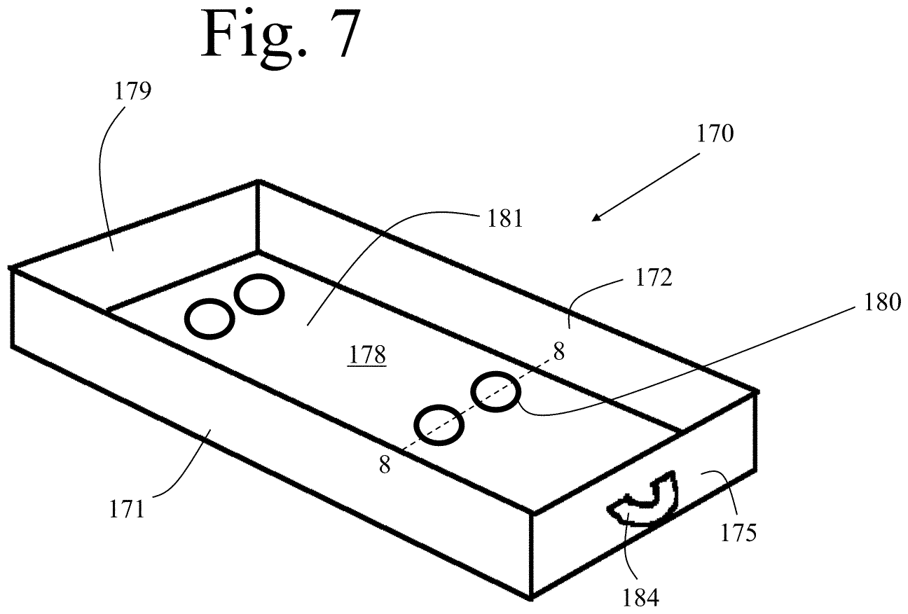

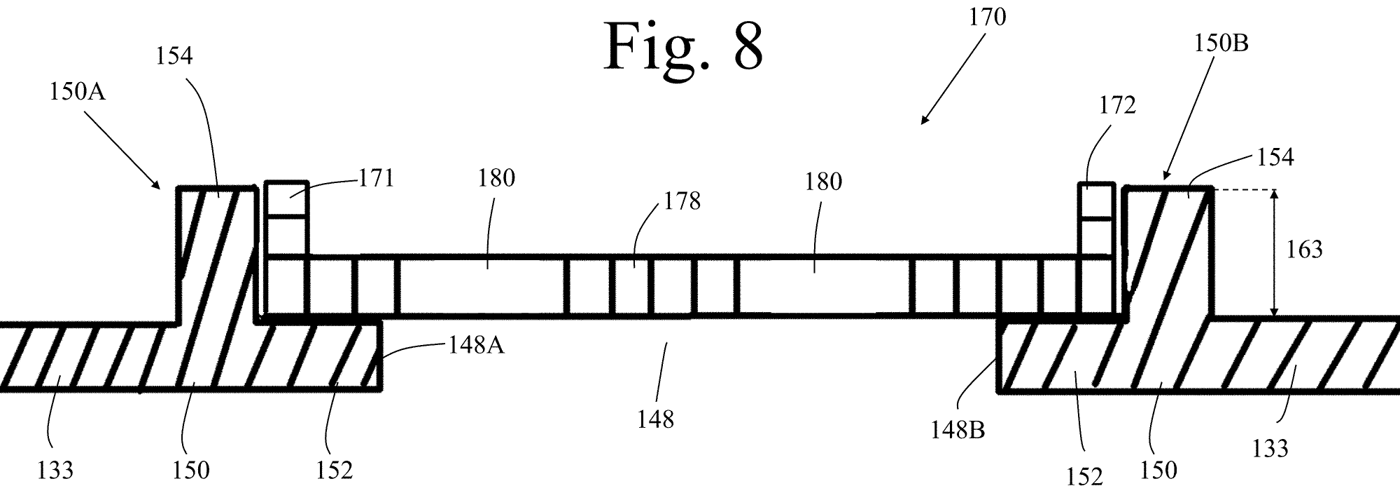

The second embodiment, illustrated in FIGS. 7 and 8, is identical with the first embodiment except that the exchangeable plate is replaced with an exchangeable tray with necessary modifications made to the guides so that they can effectively engage with the tray.

FIG. 7 is a perspective view of an exchangeable tray in accordance with this embodiment. The exchangeable tray 170 has two opposing sidewalls 171 and 172, a front plate 175, and a bottom plate 178. The exchangeable tray preferably further has a backplate 179. The sidewalls and plates 171, 172, 175, 178 and 179 share commons edges where they meet and together, they define an interior space 181 that is substantially a rectangular prism. Attached to the front plate 175 is a means 184 for pulling the tray 170 out of the lower base member when needed. Such means can be any of the conventional designs, such as one or more finger-receiving recesses, loops, rings, handles, knobs, bars and/or lips.

Similar to FIG. 5 in the first embodiment, FIG. 8 is a cross-sectional view showing an opening 148 in a part of the bottom 133 of the lower base member, and the exchangeable tray 170 that is adapted to engage with the opening 148 (see cut line 8-8 in FIG. 7). The opening 148 extends in a width direction between two opposing edges 148A and 148B, and extends in a length direction from a side opening on a first sidewall to the interior of the bottom 133, preferably reaching a second sidewall that is opposed to the first sidewall, and optionally terminating at a side opening on the second sidewall. Guides 150A and 150B are provided adjacent to each of the edges 148A and 148B to engage with the exchangeable tray 170. The guides 150A and 150B extend in a length direction that is substantially along the length direction of the edges 148A and 148B. Each guide has substantially an “L” shaped cross section, comprising a horizontal portion 152 and a vertical portion 154. The horizontal portion 152 can merge into the bottom 133 adjacent to the edges 148A and 148B (as shown in FIG. 8), or it can be a separate element placed on top and attached to the part of the bottom 133 immediately adjacent to the edges (similar to how 52 is separate from and joined to 33 in FIG. 5B). The vertical portion 154 extends from the bottom 133 of the lower base member for a distance 163 that is similar to or more than the depth of the bedding that is typically used for the pet cage. Similar to what is described above, the distance 163 is about 1 to 3 inches, and preferably about 2 inches.

When the exchangeable tray 170 is placed into the side opening 146A in a sidewall and further into the opening 148 in the bottom 133 of the lower base member, the undersides of the exchangeable tray that are located directly under the sidewalls 171 and 172 come into contact with and rest on top of the horizontal portion 152.

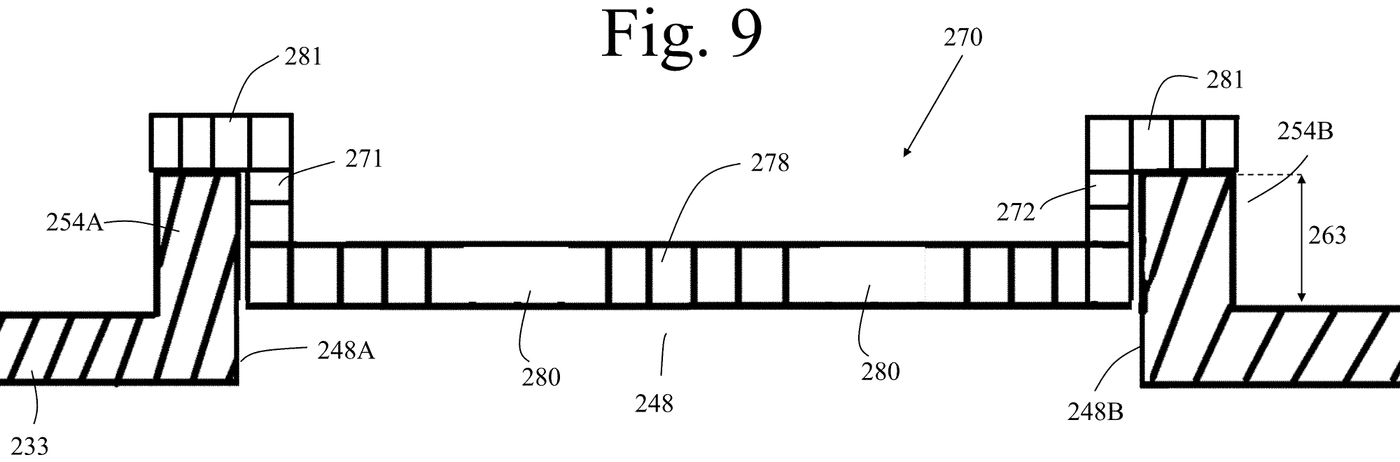

The exchangeable trays can also be designed to engage with the bottom of the lower base member in a different manner. Similar to FIG. 8, FIG. 9 is a cross-sectional view showing an opening 248 of the bottom 233 of the lower base member, and an exchangeable tray 270 that is adapted to engage with the opening 248. The opening 248 extends in a width direction between two opposing edges 248A and 248B, and extends in a length direction from a side opening on a first sidewall to the interior of the bottom 233, preferably reaching a second sidewall that is opposed to the first sidewall, and optionally terminating at a side opening on the second sidewall. Guides 254A and 254B are provided adjacent to the edges 248A and 248B. The guides 254A and 254B extend in a length direction that is substantially along the length direction of the edges 248A and 248B. The guides 254A and 254B extend in a height direction for a distance 263 from the inner surface of the bottom 233. The distance 263 is similar to or more than the depth of the bedding that is typically used for the pet cage. Similar to what is described above, the distance 263 is about 1 to 3 inches, and preferably about 2 inches.

The exchangeable tray 270 has two opposing sidewalls 271 and 272, a front plate 275, and a bottom plate 278, and preferably further has a backplate 279. The exchangeable tray 270 has a lip 281 on top of the sidewalls 271 and 272. The lip 281 extends from the sidewalls 271 and 272 horizontally and outwardly in relation to the interior space of the exchangeable tray 270. When the exchangeable tray 270 is inserted into the opening 248, the underside of the lip 281 comes into contact with the top surface of the guides 254A and 254B, thereby supporting the weight of the exchangeable tray 270 on the bottom 233 of the lower base member.

Similar to the body portion 70C in the first embodiment, the bottom plate 178/278 can have various designs, including those with or without access points (similar to what are shown in FIGS. 6A through 6D). When the cage is kept indoors, an exchangeable tray without any access points (e.g., through-holes) is placed inside the lower base member. When the cage is moved outdoors for access to fresh grass, an exchangeable tray with one or more access points is placed inside the lower base member.

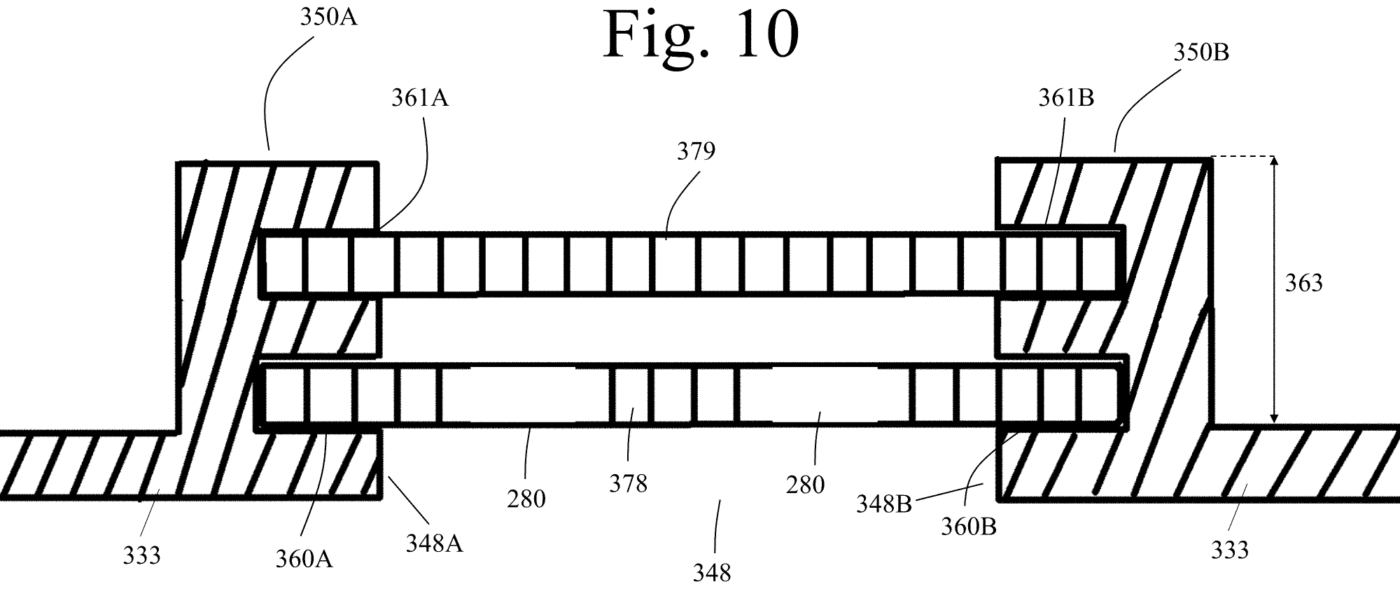

The third embodiment, illustrated in FIG. 10, is substantially identical with the first embodiment except that the guides are modified to accommodate two or more exchangeable plates. Similar to FIG. 5 in the first embodiment, FIG. 10 is a cross-sectional view showing an opening 348 in a part of the bottom 333 of the lower base member, and two exchangeable plates 378 and 379 that are adapted to engage with the opening 348. The opening 348 extends in a width direction between two opposing edges 348A and 348B, and extends in a length direction from a side opening on a first sidewall to the interior of the bottom 333, preferably reaching a second sidewall that is opposed to the first sidewall, and optionally terminating at a side opening on the second sidewall. Two “F”-shaped guides 350A and 350B are provided adjacent edges 348A and 348B. The guides 350A and 350B extend in a length direction that is substantially along the length direction of the edges 348A and 348B. The guides 350A and 350B extend in a height direction for a distance 363 from the inner surface of the bottom 333. The distance 363 is similar to or more than the bedding that is typically used for the pet cage. Similar to what is described above, the distance 263 is about 1 to 3 inches, and preferably about 2 inches.

The body portion of the exchangeable plates 378 and 379 can be designed according to the first embodiment. See FIGS. 6A through 6D. For example, the exchangeable plate 378 (the lower plate) may be a plate with one or more access points (e.g., through-holes) in its body portion, and the exchangeable plate 379 (the upper plate) may be a plate with no access points in its body portion. When the cage is indoors, both exchangeable plates can be inserted inside the cage as shown in FIG. 10. The exchangeable plate 379 presents an uninterrupted upper surface that can hold the bedding material or otherwise be available to the pet as a walking surface. When the cage is outdoors and access to fresh grass is desired, the exchangeable plate 379 is removed, exposing the exchangeable plate 378 to the pet. The pet can access fresh grass through the holes in the exchangeable plate 378. Once grass feeding is completed, the exchangeable plate 379 can be replaced, recreating the uninterrupted surface.

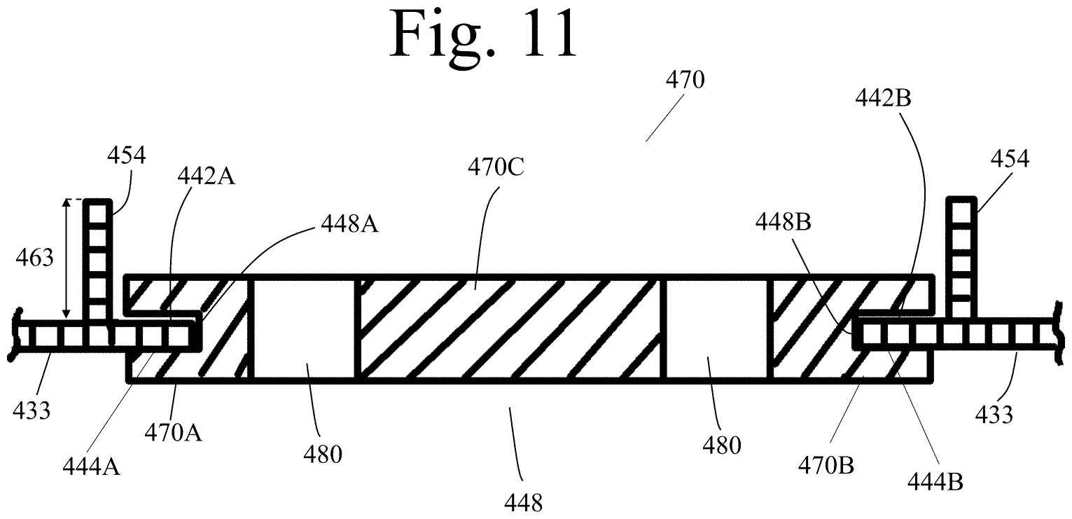

The fourth embodiment, illustrated in FIG. 11, is substantially identical with the first embodiment except that the exchangeable plate has two edge portions, each of which has a channel defined therein for engaging with an edge portion of the bottom of the lower base member adjacent to the opening. Similar to FIG. 5 in the first embodiment, FIG. 11 is a cross-sectional view showing an opening 448 in a part of the bottom 433 of the lower base member, and an exchangeable plate 470 with two edge portions 470A and 470B having channels 442A and 442B defined therein. The opening 448 extends in a width direction between two opposing edges 448A and 448B, and extends in a length direction from a side opening on a first sidewall to the interior of the bottom 433, preferably reaching a second sidewall that is opposed to the first sidewall, and optionally terminating at a side opening on the second sidewall. The opposing edges 448A and 448B are the side edges of edge portions 444A and 444B of the bottom 433. The edge portions 470A and 470B of the exchangeable plate, and the channels 442A and 442B extend in a length direction that is substantially along the length direction of the edges 444A and 444B. Barrier members 454 are provided on the bottom 433 adjacent to the edge portions 444A and 444B, and extend in a length direction that is parallel to the edge portions 444A and 444B. The barrier members extend in a height direction for a distance 463 from the inner surface of the bottom 333. The distance 463 is similar to or more than the bedding that is typically used for the pet cage. Similar to what is described above, the distance 463 is about 1 to 3 inches, and preferably about 2 inches.

The body portion 470C of the exchangeable plate 470 can be designed according to the first embodiment. See FIGS. 6A through 6D. For example, the body portion 470C may have access points, such as through-holes 480.

The exchangeable plate 470 can be readily installed on or removed from the lower base member. To install an exchangeable plate, the caretaker would insert a first end 452A of the exchangeable plate 470 into the side opening 446A on the lower base member, with the edges 444A and 444B of the bottom 433 inserted into the corresponding channels 442A and 442B of the exchangeable plate. The caretaker would then continue pushing the plate into the interior of the bottom 433 until the exchangeable plate 470 is fully inserted, at which point 470C substantially covers up the entire bottom opening 448. As fully inserted, the second end 452B of the exchangeable plate 470 abuts the side opening 446A. The first end 452A of the exchangeable plate 470 abuts the inside of the opposing sidewall 434C or, if a side opening 446B is provided on the side wall 434C, the side opening 446B. To remove an exchangeable plate, the caretaker would pull the plate toward either the side opening 446A or 446B until the exchangeable plate is completely disengaged from the lower base member.

In all the preceding embodiments, all parts of the cage can be made of any suitable materials, such as a metal, a plastic, or a metal coated with plastic. Examples of suitable metal materials include aluminum, copper, brass, steel, and stainless steel, and the metal parts may be further galvanized. Suitable plastics for making these parts or coating metal parts are well known in the art, and examples include polyolefins, acrylics, epoxies, polyimide-imides, polyesters, polyesterim ides, polyam ides, polyimides, polysulfones and polyurethanes and co-polymers thereof, such as those described U.S. Pat. Nos. 3,617,364, 3,829,545, 3,893,642, 4,521,363, 4,541,980, U.S. Patent Application Publication No. 20080193755, which are incorporated herein by reference. Particularly preferred polymer materials include polyethylene, polypropylene, polycarbonates, polyethylene terephthalate, polyacrylates (e.g., poly(methyl methacrylate)), acrylonitrile butadiene styrene (ABS) and polyvinyl chloride. The wires are preferably metal coated with a plastic. The lower base member, the exchangeable plates, and the exchangeable trays are preferably formed entirely of a plastic.

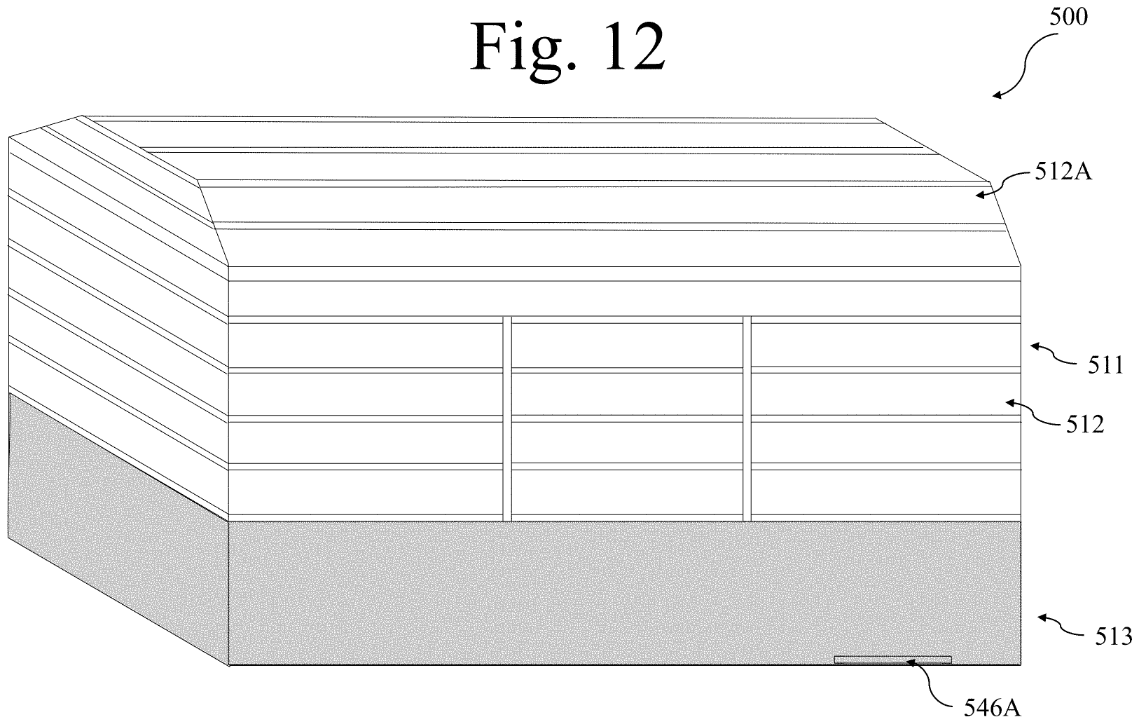

The invention focuses on the modifications made to the bottom and sidewalls of the lower base member. As a result, the upper cage member can be in any known shape or form. For example, the pet cage in accordance with the present invention may have a more modern design 500 shown in FIG. 12, which Cinnamon lives in. In this design, the cage has an upper cage member 511 comprising a plurality of sidewalls forming an enclosure 512 and a lid 512A. The lid 512A has a generally trapezoidal or semi-circular cross section and is rotatably attached to the upper perimeter of a sidewall by hinges. The cage further has a lower base member 513 showing a side opening 546A immediately adjacent to the bottom of the lower base member.

The invention also contemplates a design where the use of an exchangeable plate with access points, or an exchangeable tray with a bottom plate having access points, is entirely avoided. In this case, an exchangeable plate without any access point or an exchangeable tray with a bottom plate having no access points are used when the pet is indoors, and are removed without replacement when the pet is placed outdoors for grass feeding. In this design, the opening 48, 148, 248, 348, or 448 are the access points. However, this design is disfavored due to the absence of structural support provided by an exchangeable plate or exchangeable tray, and the risk of the pet falling out of or escaping from the opening during transport.

Although the invention has been described in conjunction with preferred forms thereof, it will be appreciated by those skilled in the art, that additions, modifications, substitutions, and deletions may be made without departing from the spirit or scope of the invention as defined in the appended claims.

We claim:

1. A pet cage comprising:
an upper cage member;
a lower base member having a plurality of sidewalls and a bottom, said bottom having an opening; and
an exchangeable plate having one or more access points;
wherein the opening is adapted to receive the exchangeable plate.

2. The pet cage according to claim 1, wherein said opening having a first edge and a second edge, said bottom having a first guide and a second guide, said first guide defining a first recessed space, said second guide defining a second recessed space, said first guide is located adjacent to and alongside the first edge, the second guide is located adjacent to and alongside the second edge, and said exchangeable plate being adapted to slide along the first recessed space and the second recessed space.

3. The pet cage according to claim 1, further comprising a second exchangeable plate.

4. The pet cage according to claim 3, wherein said second exchangeable plate is without any access points.

5. The pet cage according to claim 4, wherein said opening having a first edge and a second edge, said bottom having a first guide and a second guide, said first guide defining a first recessed space and a second recessed space, said second guide defining a third recessed space and a fourth recessed space, said first guide is located adjacent to and alongside the first edge, the second guide is located adjacent to and alongside the second edge, and said exchangeable plate having one or more access points being adapted to slide along the first recessed space and third recessed space, and said second exchangeable plate being adapted to slide along the second recessed space and fourth recessed space.

6. The pet cage according to claim 5, wherein said exchangeable plate having one or more access points being placed directly above said second exchangeable plate in a direction that is opposite from said bottom.

7. The pet cage according to claim 2, wherein the first and second guides each has a height that is between about 1 to about 3 inches.

8. The pet cage according to claim 5, wherein the first and second guides each has a height that is between about 1 to about 3 inches.

9. The pet cage according to claim 1, wherein said opening having a first edge portion and a second edge portion, said exchangeable plate has a first edge portion and a second edge portion, said first edge portion of said exchangeable plate having a first channel defined therein, said second edge portion of said exchangeable plate having a second channel defined therein, said first edge portion of said opening being adapted to slide within said first channel, and said second edge portion of said opening being adapted to slide within said second channel.

10. A pet cage comprising:
an upper cage member;
a lower base member having a plurality of sidewalls and a bottom, said bottom having an opening; and
an exchangeable tray having a front plate, a bottom plate, a first sidewall and a second sidewall;
wherein said bottom plate has at least one access point, and said opening is adapted to receive said exchangeable tray.

11. The pet cage according to claim 10, wherein said bottom having a first guide and a second guide, said first guide and second guide being adapted to support said exchangeable tray.

12. The pet cage according to claim 10, wherein said first sidewall having a horizontally-extending first lip, said second sidewall having a horizontally-extending second lip, said bottom having a first guide and a second guide, said first guide being adapted to support the exchangeable tray by the first lip, said second guide being adapted to support the exchangeable try by the second lip.

13. A pet cage comprising:
an upper cage member;
a lower base member having a plurality of sidewalls and a bottom, said bottom having an opening; and
an exchangeable plate;
wherein the opening is adapted to receive the exchangeable plate.
